(19) United States
(12) Patent Application Publication
(10) Pub. No.: US 2011/0268302 A1
(43) Pub. Date: Nov. 3, 2011

(54) HEARING AID

(75) Inventors: Meng Kiang Lim, Singapore (SG); Peilin Phui, Singapore (SG)

(73) Assignee: SIEMENS MEDICAL INSTRUMENTS PTE. LTD., Singapore (SG)

(21) Appl. No.: 13/063,603

(22) PCT Filed: Sep. 11, 2008
(86) PCT No.: PCT/SG08/00341

§ 371 Date: May 19, 2011

(51) Int. Cl. H04R 25/00

(52) U.S. Cl. 381/322

(57) ABSTRACT

A hearing aid contains a hearing aid housing having a receiving portion and a support structure positioned within the hearing aid housing. The support structure contains a substrate having an electronic circuit and a support member coupled to the substrate. The support member is configured to be adhered to the substrate, and the support structure is coupled to the receiving portion.

Embodiments relate to a hearing aid.

A hearing aid is usually fitted in or behind the ear of the user to amplify the sound for the user. Some popular types of hearing aids include behind-the-ear (BTE) aids, in the ear (ITE) aids, in the canal (ITC) aids, completely in the canal (CIC) aids, etc.

A hearing aid usually includes a hearing aid housing, within which a plastic frame for supporting and keeping a printed circuit board (PCB) in a desired position within the hearing aid housing may be housed. A signal processing circuit or other circuits or elements which may be provided or desired to be in a hearing aid, may be provided on the printed circuit board.

As hearing aids are generally desired to be small, space within a hearing aid is usually limited. Therefore, it may be desired to reduce the number or size of components needed in the hearing aid. Further, the reduction of the number or size of components may allow an increase in efficiency during assembly of the components to arrive at the resultant hearing aid.

In various embodiments, a hearing aid is provided, which may include a support structure which may be able to provide a reasonable support to the PCB while reducing the space needed within the hearing aid. Further, the support structure may allow the PCB to conform to the design of the hearing aid housing.

An embodiment relates to a hearing aid. The hearing aid may include a hearing aid housing, the hearing aid housing including a receiving portion. The hearing aid may further include a support structure positioned within the hearing aid housing. The support structure may include a substrate having an electronic circuit and a support member coupled to the substrate, the support member being configured to be adhered to the substrate. The support structure may be coupled to the receiving portion.

In an embodiment, the support member may be adhered to the substrate by using additional adhering material such as e.g. a solder material or any other suitable adhering material such as e.g. an adhesive.

In an embodiment, the receiving portion may include any suitable engaging member which may be complementary to the support member. The receiving portion together with the support member may be used to hold the substrate in place within the hearing aid housing.

In an embodiment, the support structure may be detachable from the hearing aid housing.

In an embodiment, the support structure may be directly assembled onto the hearing aid housing without an additional interface. This may help to save space, thereby allowing more components to be housed within the hearing aid housing or to reduce the size of the hearing aid housing. This may also help to increase efficiency during assembly.

In an embodiment, the hearing aid housing may include a top housing portion and a bottom housing portion. The top housing portion may be positioned above the substrate and the bottom housing portion may be positioned below the substrate.

In an embodiment, the top housing portion may be configured to be fitted with the bottom housing portion, thereby enclosing the support structure. Each of the top housing portion and the bottom housing portion may include a suitable engaging member such that the top housing portion may be detachable from the bottom housing portion or such that the top housing portion may be in permanent contact with the bottom housing portion to form a sealed environment, depending on requirements. The top housing portion and the bottom housing portion may prevent the support structure from falling out of the hearing aid housing.

In an embodiment, the hearing aid housing may include a first side housing portion and a second side housing portion. The first side housing portion may be positioned adjacent to one side of the substrate and the second side housing portion may be positioned adjacent to an opposite side of the substrate.

In an embodiment, the first side housing portion may be configured to be fitted with the second side housing portion, thereby enclosing the support structure. Each of the first side housing portion and the second side housing portion may include a suitable engaging member such that the first side housing portion may be detachable from the second side housing portion or such that the first side housing portion may be in permanent contact with the second side housing portion to form a sealed environment, depending on requirements. The first side housing portion and the second side housing portion may prevent the support structure from falling out of the hearing aid housing.

In an embodiment, the receiving portion may include a first support slot and a second support slot. The receiving portion may include a plurality of first support slots and a plurality of second support slots depending on requirements. The number of first support slot(s) may be the same as or different from the number of second support slot(s). The first support slot and the second support slot may be termed as locks as the first support slot and the second support slot may help to lock and hold the support structure in place within the hearing aid housing.

In an embodiment, the first support slot and the second support slot may be positioned in the bottom housing portion. The first support slot and the second support slot may also be positioned in the top housing portion. The first support slot and the second support slot may be positioned at any position along the perimeter of the bottom housing portion or the top housing portion depending on requirements, for example. The first support slot may be positioned opposite to the second support portion. The first support portion may be positioned directly opposite to the second support portion or opposite in a substantially diagonal manner.

In an embodiment, the first support slot may be positioned in the first side housing portion and the second support slot may be positioned in the second side housing portion. The first support slot and the second support slot may be respectively positioned at any suitable position along the perimeter of the first side housing portion and the second side housing portion. The first support slot may be positioned opposite to the second support portion. The first support portion may be positioned directly opposite to the second support portion or opposite in a substantially diagonal manner.

In an embodiment, the substrate may include a first contact portion and a second contact portion. The substrate may include a plurality of first contact portions and a plurality of second contact portions depending on requirements. The number of first contact portion(s) may be the same as or different from the number of second contact portion(s).

In an embodiment, the support member may include a first support portion and a second support portion. The first support portion and the second support portion may be positioned along the opposing edges of the substrate. The first support portion and the second support portion may also be positioned at suitable positions along the substrate where support for the substrate may be needed due to a pressing down force from a push button or a rocker switch or at a suitable position near to a tact switch. The support member may include, a plurality of first support portions and a plurality of second support portions depending on requirements. The number of first support portion(s) may correspond to the number of first contact portion(s) and the number of second support portion(s) may correspond to the number of second contact portion(s). Each of the first support portion(s) and the second support portion(s) may be of any suitable dimensions, for example in relation to the length of the substrate or depending on requirements.

In an embodiment, the first support portion may be positioned to be in contact with the first contact portion of the substrate.

In an embodiment, the second support portion may be positioned to be in contact with the second contact portion of the substrate.

In an embodiment, the first support portion may be configured to be fitted into the first support slot and the second support portion may be configured to be fitted into the second support slot. The number of first support portion(s) may correspond to the number of first support slot(s) and the number of second support portion(s) may correspond to the number of second support slot(s).

In an embodiment, the hearing aid housing may include or may be made of a plastic material, a stereolithography (SLA) material or a powder injection molding (PIM) material.

In an embodiment, the substrate may include a flexible, rigid-flex or rigid material. The flexible and rigid-flex material may allow the substrate to conform to the contours of the hearing aid housing. The substrate may include one or a plurality of electronic circuits. Each of the electronic circuit may include a surface mount device (SMD), an application-specific integrated circuit (ASIC), for example. The substrate may also include copper traces for electrically connecting the electronic circuits.

In an embodiment, the substrate may include a printed circuit board.

In an embodiment, the first support portion may include a metal material or a solder-compatible material. The type of solder-compatible material may be dependent on the surface finish.

In an embodiment, the first support portion may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered.

In an embodiment, the second support portion may include a metal material or a solder-compatible material.

In an embodiment, the second support portion may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered.

In an embodiment, the second support portion may be of the same material or of a different material from the first support portion, depending on requirements. The first support portion and the second support portion may be a single integrated portion.

In an embodiment, the first support portion may include an L-shape, a C-shape or a Z-shape structure or any suitable structures. The first support portion may include any suitable shapes depending on design requirements. The first support portion may be in contact with one or two surfaces of the substrate, depending on design requirements. By way of example, the two surfaces of the substrate may be substantially perpendicular to each other like in the L-shape structure or may be substantially parallel to each other like in the Z-shape or in the C-shape structure.

In an embodiment, the second support portion may include an L-shaped structure, a C-shape or a Z- or any suitable structures. The second support portion may be in contact with one or two surfaces of the substrate, depending on design requirements. The second support portion may include any suitable shapes depending on design requirements. By way of example, the two surfaces of the substrate may be substantially perpendicular to each other like in the L-shape structure or may be substantially parallel to each other like in the Z-shape or in the C-shape structure.

In an embodiment, the first support portion may be of the same shape or of a different shape from the second support portion.

An embodiment relates to a hearing aid support structure. The hearing aid support structure may include a substrate having an electronic circuit; and a support member coupled to the substrate, the support member being configured to be adhered to the substrate.

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

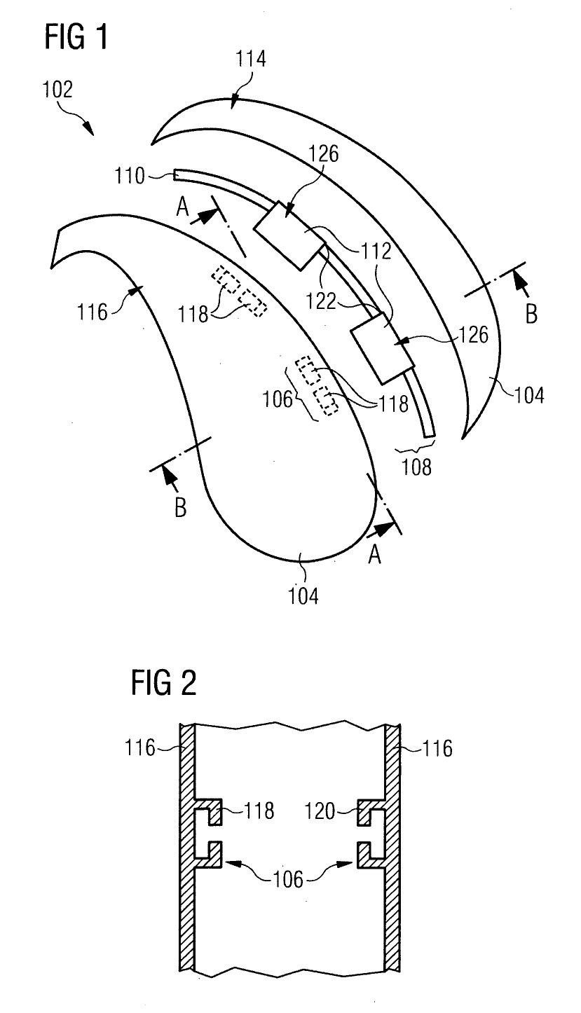

FIG. 1 shows a hearing aid according to an embodiment;

FIG. 2 shows a cross-sectional view of the hearing aid of FIG. 1 along line A-A according to an embodiment;

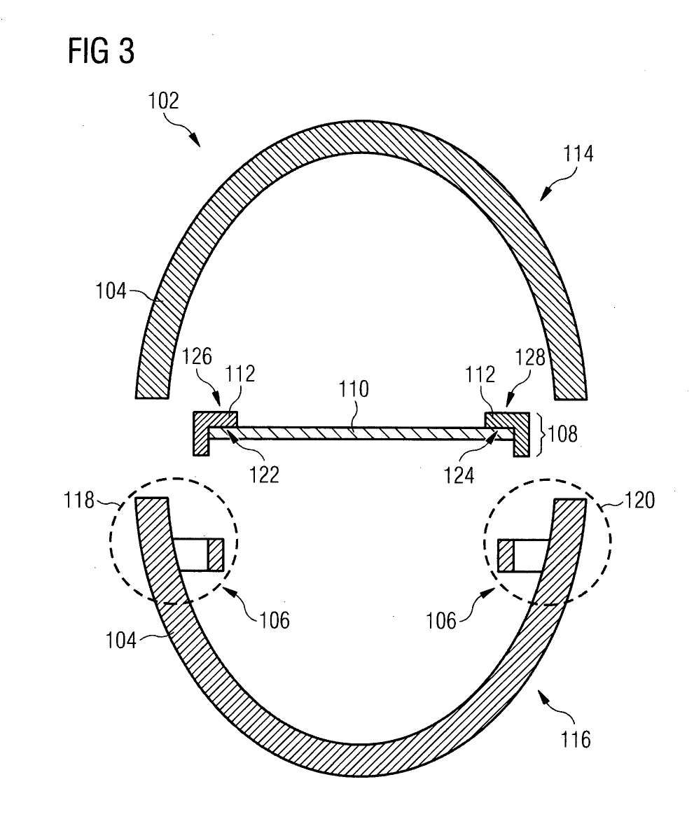

FIG. 3 shows a cross-sectional view of the hearing aid of FIG. 1 along line B-B according to an embodiment;

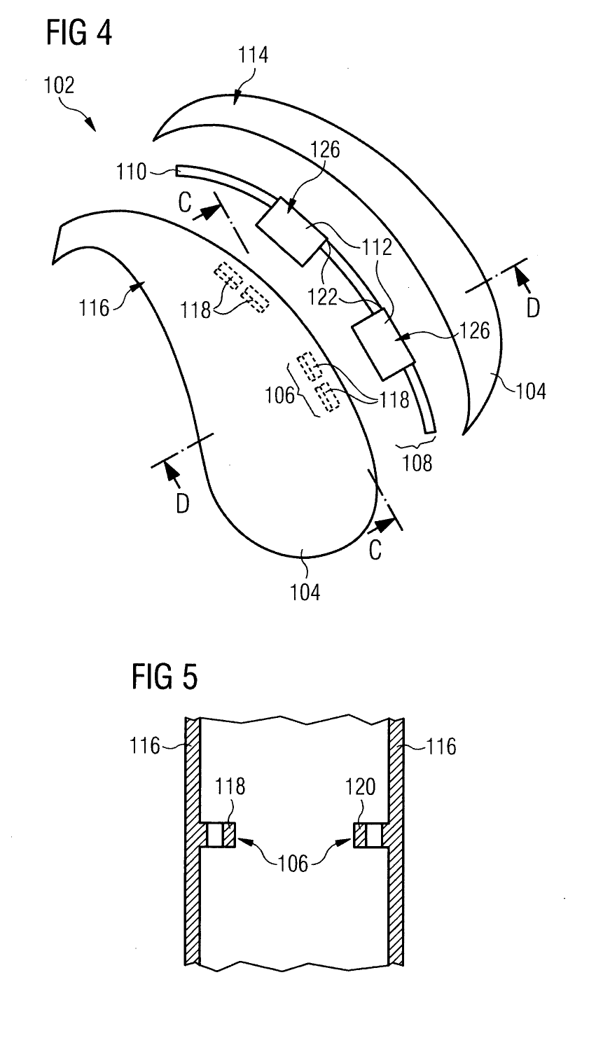

FIG. 4 shows a hearing aid according to an embodiment;

FIG. 5 shows a cross-sectional view of the hearing aid of FIG. 4 along line C-C according to an embodiment;

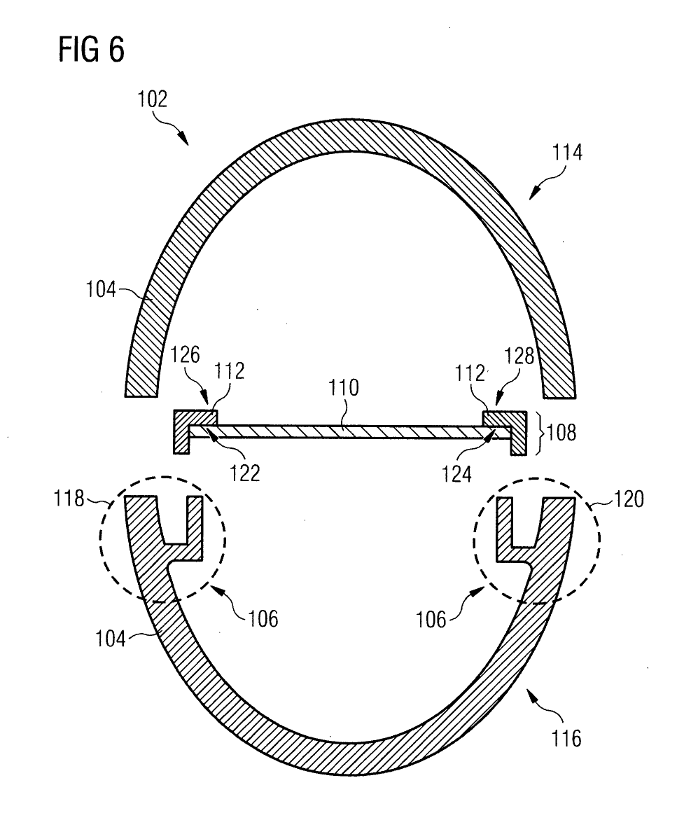

FIG. 6 shows a cross-sectional view of the hearing aid of FIG. 4 along line D-D according to an embodiment;

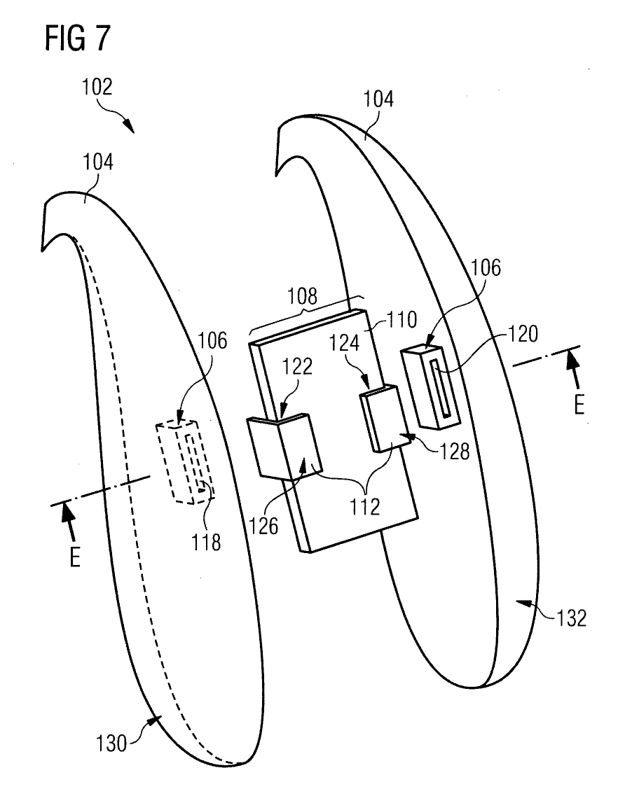

FIG. 7 shows a hearing aid according to an embodiment; and

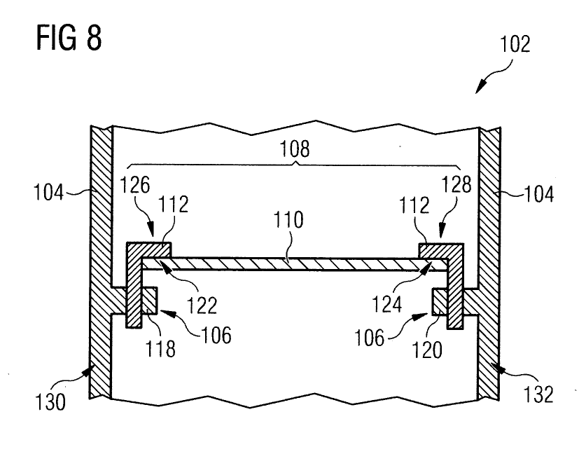

FIG. 8 shows a cross-sectional view of the hearing aid of FIG. 7 along line E-E according to an embodiment.

FIG. 1 shows a hearing aid 102 according to an embodiment. The hearing aid 102 may include a hearing aid housing 104, the hearing aid housing 104 including a receiving portion 106. The hearing aid 102 may further include a support structure 108 positioned within the hearing aid housing 104. The support structure 108 may include a substrate 110 having an electronic circuit and a support member 112 coupled to the substrate 110, the support member 112 being configured to be adhered (e.g. by means of additional adhering material) to the substrate 110. The support structure 108 may be coupled to the receiving portion 106. The support member 112 may be configured to be adhered to the substrate 110 via a solder material or any suitable material such as e.g. an adhesive.

The hearing aid housing 104 may include a top housing portion 114 and a bottom housing portion 116. The top housing portion 114 may be configured to be fitted with the bottom housing portion 116, thereby enclosing the support structure 108.

The receiving portion 106 (as shown in dotted lines) may include two first support slots 118 and two second support slots (not shown). The first support slots 118 and the second support slots may be positioned in the bottom housing portion 116.

The substrate 110 may include two first contact portions 122 and two second contact portions (not shown).

The support member 112 may include two first support portions 126 and two second support portions (not shown). Each of the first support portions 126 may be positioned to be in contact with each of the first contact portions 122 of the substrate 110 and each of the second support portions may be positioned to be in contact with each of the second contact portions of the substrate 110.

Each of the first support portions 126 may be configured to be fitted into each of the first support slot 118 and each of the second support portions may be configured to be fitted into each of the second support slots.

The hearing aid housing 104 may include a plastic material, a stereolithography (SLA) material or a powder injection molding (PIM) material.

The substrate 110 may include a flexible, rigid-flex or rigid material. The substrate 110 may include a printed circuit board.

Each of the first support portions 126 may include a metal material or a solder-compatible material. The type of solder-compatible material may be dependent on the surface finish.

Each of the first support portions 126 may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered.

Each of the second support portions may include a metal material or a solder-compatible material. The type of solder-compatible material may also be dependent on the surface finish. Each of the second support portions may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered. Each of the second support portions may be of the same material as each of the first support portions 126.

FIG. 2 shows a cross-sectional view of the hearing aid 102 of FIG. 1 along line A-A according to an embodiment. FIG. 2 shows a receiving portion 106 on a bottom housing portion 116. The bottom housing portion 116 may include a first support slot 118 and a second support slot 120. The first support slot 118 may be positioned substantially opposite to the second support slot 120. The first support slot 118 and the second support slot 120 may be positioned along the perimeter of the bottom housing portion 116.

FIG. 3 shows a cross-sectional view of the hearing aid 102 of FIG. 1 along line B-B according to an embodiment.

The hearing aid 102 may include a hearing aid housing 104, the hearing aid housing 104 including a receiving portion 106. The hearing aid 102 may further include a support structure 108 which may be positioned within the hearing aid housing 104. The support structure 108 may include a substrate 110 having an electronic circuit and a support member 112 coupled to the substrate 110, the support member 112 being configured to be adhered to the substrate 110. The support structure 108 may be coupled to the receiving portion 106. The support member 112 may be configured to be adhered to the substrate 110 via a solder material or any suitable material.

The hearing aid housing 104 may include a top housing portion 114 and a bottom housing portion 116. The top housing portion 114 may be configured to be fitted with the bottom housing portion 116, thereby enclosing the support structure 108.

The receiving portion 106 may include a first support slot 118 and a second support slot 120. The first support slot 118 and the second support slot 120 may be positioned in the bottom housing portion 116.

The substrate 110 may include a first contact portion 122 and a second contact portion 124. The first contact portion 122 may be positioned along an edge of the substrate 110 and the second contact portion 124 may be positioned along an opposite edge of the substrate 110 so as to provide support for the substrate 110.

The support member 112 may include a first support portion 126 and a second support portion 128. The first support portion 126 may be positioned to be in contact with the first contact portion 122 of the substrate 110 and the second support portion 128 may be positioned to be in contact with the second contact portion 124 of the substrate 110.

The first support portion 126 may include an L-shape structure. The second support portion 128 may include an L-shaped structure. The first support portion 126 may be of the same shape as the second support portion 128.

The first support portion 126 may be configured to be fitted into the first support slot 118 and the second support portion 128 may be configured to be fitted into the second support slot 120.

FIG. 4 shows a hearing aid according to an embodiment. Essentially the hearing aid in FIG. 4 is similar to the hearing aid in FIG. 1 with a difference in the design of the receiving portion 106 as shown in dotted lines.

FIG. 4 shows a hearing aid 102 according to an embodiment. The hearing aid 102 may include a hearing aid housing 104, the hearing aid housing 104 including a receiving portion 106. The hearing aid 102 may further include a support structure 108 positioned within the hearing aid housing 104. The support structure 108 may include a substrate 110 having an electronic circuit and a support member 112 coupled to the substrate 110, the support member 112 being configured to be adhered (e.g. by means of additional adhering material) to the substrate 110. The support structure 108 may be coupled to the receiving portion 106. The support member 112 may be configured to be adhered to the substrate 110 via a solder material or any suitable material such as e.g. an adhesive.

The hearing aid housing 104 may include a top housing portion 114 and a bottom housing portion 116. The top housing portion 114 may be configured to be fitted with the bottom housing portion 116, thereby enclosing the support structure 108.

The receiving portion 106 (as shown in dotted lines) may include two first support slots 118 and two second support slots (not shown). The first support slots 118 and the second support slots may be positioned in the bottom housing portion 116.

The substrate 110 may include two first contact portions 122 and two second contact portions (not shown).

The support member 112 may include two first support portions 126 and two second support portions (not shown). Each of the first support portions 126 may be positioned to be in contact with each of the first contact portions 122 of the substrate 110 and each of the second support portions may be positioned to be in contact with each of the second contact portions of the substrate 110.

Each of the first support portions 126 may be configured to be fitted into each of the first support slot 118 and each of the second support portions may be configured to be fitted into the each of the second support slots.

The hearing aid housing 104 may include a plastic material, a stereolithography (SLA) material or a powder injection molding (PIM) material.

The substrate 110 may include a flexible, rigid-flex or rigid material. The substrate 110 may include a printed circuit board.

Each of the first support portions 126 may include a metal material or a solder-compatible material. The type of solder-compatible material may be dependent on the surface finish. Each of the first support portions 126 may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered.

Each of the second support portions may include a metal material or a solder-compatible material. The type of solder-compatible material may be dependent on the surface finish. Each of the second support portions may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered. Each of the second support portions may be of the same material as each of the first support portions 126.

FIG. 5 shows a cross-sectional view of the hearing aid of FIG. 4 along line C-C according to an embodiment. Essentially the cross-sectional view of the hearing aid of FIG. 4 along line C-C as shown in FIG. 5 is similar to the cross-sectional view of the hearing aid of FIG. 1 along line A-A as shown in FIG. 2 with a difference in the design of the receiving portion 106.

FIG. 5 shows the receiving portion 106 on a bottom housing portion 116. The bottom housing portion 116 may include a first support slot 118 and a second support slot 120. The first support slot 118 may be positioned substantially opposite to the second support slot 120. The first support slot 118 and the second support slot 120 may be positioned along the perimeter of the bottom housing portion 116.

FIG. 6 shows a cross-sectional view of the hearing aid of FIG. 4 along line D-D according to an embodiment. Essentially the cross-sectional view of the hearing aid of FIG. 4 along line D-D as shown in FIG. 6 is similar to the cross-sectional view of the hearing aid of FIG. 1 along line B-B as shown in FIG. 3 with a difference in the design of the receiving portion 106.

The hearing aid 102 may include a hearing aid housing 104, the hearing aid housing 104 including a receiving portion 106. The hearing aid 102 may further include a support structure 108 which may be positioned within the hearing aid housing 104. The support structure 108 may include a substrate 110 having an electronic circuit and a support member 112 coupled to the substrate 110, the support member 112 being configured to be adhered to the substrate 110. The support structure 108 may be coupled to the receiving portion 106. The support member 112 may be configured to be adhered to the substrate 110 via a solder material or any suitable material.

The hearing aid housing 104 may include a top housing portion 114 and a bottom housing portion 116. The top housing portion 114 may be configured to be fitted with the bottom housing portion 116, thereby enclosing the support structure 108.

The receiving portion 106 may include a first support slot 118 and a second support slot 120. The first support slot 118 and the second support slot 120 may be positioned in the bottom housing portion 116.

The substrate 110 may include a first contact portion 122 and a second contact portion 124. The first contact portion 122 may be positioned along an edge of the substrate 110 and the second contact portion 124 may be positioned along an opposite edge of the substrate 110 so as to provide support for the substrate 110.

The support member 112 may include a first support portion 126 and a second support portion 128. The first support portion 126 may be positioned to be in contact with the first contact portion 122 of the substrate 110 and the second support portion 128 may be positioned to be in contact with the second contact portion 124 of the substrate 110.

The first support portion 126 may include an L-shape structure. The second support portion 128 may include an L-shaped structure. The first support portion 126 may be of the same shape as the second support portion 128.

The first support portion 126 may be configured to be fitted into the first support slot 118 and the second support portion 128 may be configured to be fitted into the second support slot 120.

FIG. 7 shows a hearing aid 102 according to an embodiment. The hearing aid 102 may include a hearing aid housing 104, the hearing aid housing 104 including a receiving portion 106. The hearing aid 102 may further include a support structure 108 positioned within the hearing aid housing 104. The support structure 108 may include a substrate 110 having an electronic circuit and a support member 112 coupled to the substrate 110, the support member 112 being configured to be adhered to the substrate 110. The support structure 108 may be coupled to the receiving portion 106. The support member 112 may be configured to be adhered to the substrate 110 via a solder material or any suitable material.

The hearing aid housing 104 may include a first side housing portion 130 and a second side housing portion 132. The first side housing portion 130 may be configured to be fitted with the second side housing portion 132, thereby enclosing the support structure 108.

The receiving portion 106 may include a first support slot 118 and a second support slot 120. The first support slot 118 may be positioned in the first side housing portion 130 and the second support slot 120 may be positioned in the second side housing portion 132.

The substrate 110 may include a first contact portion 122 and a second contact portion 124.

The support member 112 may include a first support portion 126 and a second support portion 128. The first support portion 126 may be positioned to be in contact with the first contact portion 122 of the substrate 110 and the second support portion 128 may be positioned to be in contact with the second contact portion 124 of the substrate 110.

The first support portion 126 may be configured to be fitted into the first support slot 118 and the second support portion 128 may be configured to be fitted into the second support slot 120.

The hearing aid housing 104 may include a plastic material, a stereolithography (SLA) material or a powder injection molding (PIM) material.

The substrate 110 may include a flexible, rigid-flex or rigid material. The substrate 110 may include a printed circuit board.

The first support portion 126 may include a metal material or a solder-compatible material. The type of solder-compatible material may be dependent on the surface finish. The first support portion 126 may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered.

The second support portion 128 may include a metal material or a solder-compatible material. The type of solder-compatible material may be dependent on the surface finish. The second support portion 128 may include a material selected from a group consisting of aluminum, copper, gold, tin, nickel, lead, stainless steel. In general, metals like gold, tin, nickel and lead may be soldered. Other metals like copper, stainless steel may require nickel-tin plating, gold plating, nickel plating for example so as to be able to be soldered. The second support portion 128 may be of the same material as the first support portion 126.

FIG. 8 shows a cross-sectional view of the hearing aid 102 of FIG. 7 along line E-E according to an embodiment.

The hearing aid 102 may include a hearing aid housing 104, the hearing aid housing 104 including a receiving portion 106. The hearing aid 102 may further include a support structure 108 which may be positioned within the hearing aid housing 104. The support structure 108 may include a substrate 110 having an electronic circuit and a support member 112 coupled to the substrate 110, the support member 112 being configured to be adhered to the substrate 110. The support structure 108 may be coupled to the receiving portion 106. The support member 112 may be configured to be adhered to the substrate 110 via a solder material or any suitable material.

The hearing aid housing 104 may include a first side housing portion 130 and a second side housing portion 132. The first side housing portion 130 may be configured to be fitted with the second side housing portion 132, thereby enclosing the support structure 108.

The receiving portion 106 may include a first support slot 118 and a second support slot 120. The first support slot 118 may be positioned in the first side housing portion 130 and the second support slot 120 may be positioned in the second side housing portion 132.

The substrate 110 may include a first contact portion 122 and a second contact portion 124. The first contact portion 122 may be positioned along an edge of the substrate 110 and the second contact portion 124 may be positioned along an opposite edge of the substrate 110 so as to provide support for the substrate 110.

The support member 112 may include a first support portion 126 and a second support portion 128. The first support portion 126 may be positioned to be in contact with the first contact portion 122 of the substrate 110 and the second support portion 128 may be positioned to be in contact with the second contact portion 124 of the substrate 110.

The first support portion 126 may include an L-shape structure. The second support portion 128 may include an L-shaped structure. The first support portion 126 may be of the same shape as the second support portion 128.

The first support portion 126 may be configured to be fitted into the first support slot 118 and the second support portion 128 may be configured to be fitted into the second support slot 120.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1-25. (canceled)

26. A hearing aid, comprising:
a hearing aid housing having a receiving portion; and
a support structure positioned within said hearing aid housing, said support structure containing a substrate having an electronic circuit and a support member coupled to said substrate, said support member configured to be adhered to said substrate, said support structure being coupled to said receiving portion.

27. The hearing aid according to claim 26, wherein said hearing aid housing has a top housing portion and a bottom housing portion.

28. The hearing aid according to claim 27, wherein said top housing portion is configured to be fitted with said bottom housing portion, thereby enclosing said support structure.

29. The hearing aid according to claim 26, wherein said hearing aid housing further has a first side housing portion and a second side housing portion.

30. The hearing aid according to claim 29, wherein said first side housing portion is configured to be fitted with said second side housing portion, thereby enclosing said support structure.

31. The hearing aid according to claim 27, wherein said receiving portion has a first support slot formed therein and a second support slot formed therein.

32. The hearing aid according to claim 31, wherein said first support slot and said second support slot are positioned in said bottom housing portion.

33. The hearing aid according to claim 29, wherein said receiving portion has a first support slot formed therein and a second support slot formed therein, said first support slot is positioned in said first side housing portion and said second support slot is positioned in said second side housing portion.

34. The hearing aid according to claim 31, wherein said substrate has a first contact portion and a second contact portion.

35. The hearing aid according to claim 34, wherein said support member has a first support portion and a second support portion.

36. The hearing aid according to claim 35, wherein said first support portion is positioned to be in contact with said first contact portion of said substrate.

37. The hearing aid according to claim 35, wherein said second support portion is positioned to be in contact with said second contact portion of said substrate.

38. The hearing aid according to claim 35, wherein said first support portion is configured to be fitted into said first support slot and said second support portion is configured to be fitted into said second support slot.

39. The hearing aid according to claim 26, wherein said hearing aid housing is formed from a plastic material, a stereolithography material and/or a powder injection molding material.

40. The hearing aid according to claim 26, wherein said substrate includes a flexible material, a rigid-flex material, and/or a rigid material.

41. The hearing aid according to claim 26, wherein said substrate has a printed circuit board.

42. The hearing aid according to claim 35, wherein said first support portion has a metal material or a solder-compatible material.

43. The hearing aid according to claim 35, wherein said first support portion contains a material selected from a group consisting of aluminum, copper, gold, tin, nickel, lead, and stainless steel.

44. The hearing aid according to claim 35, wherein said second support portion contains a metal material or a solder-compatible material.

45. The hearing aid according to claim 35, wherein said second support portion contains a material selected from a group consisting of aluminum, copper, gold, tin, nickel, lead, and stainless steel.

46. The hearing aid according to claim 35, wherein said second support portion is of a same material as said first support portion.

47. The hearing aid according to claim 35, wherein said first support portion includes an L-shape structure.

48. The hearing aid according to claim 35, wherein said second support portion includes an L-shaped structure, a C-shaped structure, and/or a Z-shaped structure.

49. The hearing aid according to claim 35, wherein said first support portion is of a same shape as said second support portion.

50. A hearing aid support structure, comprising:
a substrate having an electronic circuit; and
a support member coupled to said substrate, said support member being configured to be adhered to said substrate.
